(19) United States
(12) Patent Application Publication
(10) Pub. No.: US 2014/0241507 A1
(43) Pub. Date: Aug. 28, 2014

(54) ELECTRICAL ENERGY SUPPLY SYSTEM

(71) Applicant: KONINKLIJKE PHILIPS N.V., EINDHOVEN (NL)

(72) Inventors: Oliver Woywode, Hamburg (DE); Christian Düerkop, Aerzen (DE); Klaus F. Hoffmann, Hamburg (DE)

(73) Assignee: KONINKLIJKE PHILIPS N.V., EINDHOVEN (NL)

(21) Appl. No.: 14/348,631

(22) PCT Filed: Oct. 15, 2012
(86) PCT No.: PCT/IB2012/055604

§ 371 Date: Mar. 31, 2014

Related U.S. Application Data
(60) Provisional application No. 61/548,251, filed on Oct. 18, 2011.

(51) Int. Cl. H02M 3/335; H05G 1/18

(52) U.S. Cl. CPC H02M 3/33569; H05G 1/18
USPC 378/107; 363/17

(57) ABSTRACT

An electrical energy supply system (12) comprises an input rectifier (14) for rectifying an input voltage into a DC voltage, an inverter (18) with semiconductor switches for generating an AC output voltage from the DC voltage and a controller (24) for switching the switches of the inverter (18). The inverter (18) is adapted for generating a 5-level AC output voltage. The controller (18) is adapted to switch the semiconductor switches such that an asymmetric pulse shape is generated from the inverter (18) in a half cycle of the AC output voltage.

### FIELD OF THE INVENTION

The invention relates to an electrical energy supply system, an X-ray device, a use of an electrical energy supply system and a method for supplying electrical energy to a load.

### BACKGROUND OF THE INVENTION

In many high power devices like X-ray imaging devices, an AC input voltage from an electrical grid is rectified and transformed into an AC output voltage that may have a different frequency and magnitude as the AC input voltage. The AC output voltage may be used for supplying a load. For example, in specific X-ray devices the AC output voltage is supplied to a step-up transformer, rectified and used for operating an X-ray tube.

In particular, in such high power applications, mains for a three-phase AC input voltage may be connected to a B6-diode-rectifier (three half-bridges) as front-end, which generates an unregulated DC voltage supplied to a DC-link. The AC input voltage range is expected from 380-480V AC depending on the countries mains voltage. Taking into account the mains impedances and the voltage tolerances this may result in a DC-link voltage range of nearly 400-750V. In order to utilize general purpose 600V power semiconductors in the following high frequency switching inverter (for example a H-bridge-inverter), an additional DC-DC converter, for example a buck converter, between the diode rectifier and the inverter may be necessary to stabilize the DC-link voltage (for example to 400V) that is input to the inverter.

EP 2 286 423 A1 shows such an X-ray device with a two-level inverter for power supply.

In motor drive applications, the usage of 5-level NPC clamped inverters is known.

### SUMMARY OF THE INVENTION

The operation costs of a high power device like an X-ray imaging device may strongly depend on the energy consumption of the high power components. The energy consumption may be reduced by lowering switching losses of power semiconductors and by enhancing the power factor of the inverter. The switching losses of power semiconductors may be reduced by applying a method called zero-voltage-switching. However, conventionally switched 5-level inverters cannot strictly maintain zero-voltage-switching and a good power factor at the same time.

It may be an object of the invention to provide an electrical energy supply system with both, low switching losses obtained by zero-voltage-switching and a high power factor simultaneously.

This object is achieved by the subject-matter of the independent claims. Further exemplary embodiments are evident from the dependent claims and the following description.

An aspect of the invention relates to an electrical energy supply system, for example the power supply of an X-ray device.

According to an embodiment of the invention, the electrical energy supply system comprises an input rectifier for rectifying an input voltage into a DC voltage, an inverter with semiconductor switches for generating an AC output voltage from the DC voltage and a controller for generating the switching signals of the switches of the inverter. The inverter is adapted for generating a 5-level AC output voltage and the controller is adapted to switch the switches such that an asymmetric or symmetric pulse shape may be generated from the inverter in a half cycle of the AC output voltage.

With the applied modulation method of a 5-level inverter for energy transfer, a zero-voltage-switching may be strictly respected. The modulation method allows for the generation of asymmetric pulse shapes in order to obtain a power factor close to one. The modulation method reduces the root-mean-square value of the inverter output current and hence losses.

A further aspect of the invention relates to an X-ray device with such an electrical energy supply system.

A further aspect of the invention relates to a use of such an energy supply system in an X-ray device for supplying an X-ray tube with electrical energy.

A further aspect of the invention relates to a method for supplying a load with electrical energy, which may be executed by such an energy supply system.

According to an embodiment of the invention, the method comprises the steps of:

rectifying an input voltage into a DC voltage; generating a 5-level AC output voltage from the DC voltage with a 5-level inverter; controlling the inverter such that an asymmetric pulse shape in a half cycle of the AC output voltage is generated.

It has to be understood that features of the method as described in the above and in the following may be features of the energy supply system as described in the above and in the following and vice versa.

These and other aspects of the invention will be apparent from and elucidated with reference to the embodiments described hereinafter.

### BRIEF DESCRIPTION OF THE DRAWINGS

Below, embodiments of the present invention are described in more detail with reference to the attached drawings.

FIG. 1 shows an X-ray device according to an embodiment of the invention.

FIG. 2 shows a circuit diagram according to an embodiment of the invention.

FIG. 3 shows a diagram with an output voltage having a symmetric pulse shape of an inverter according to an embodiment of the invention.

FIG. 4 shows a diagram with a further output voltage having an asymmetric pulse shape of an inverter according to an embodiment of the invention.

FIG. 5 shows a diagram with a further output voltage of an inverter according to an embodiment of the invention.

FIG. 6 shows a diagram with a further output voltage of an inverter according to an embodiment of the invention.

FIG. 7 shows a diagram with a further output voltage of an inverter according to an embodiment of the invention.

In principle, identical parts are provided with the same reference symbols in the figures.

### DETAILED DESCRIPTION OF EMBODIMENTS

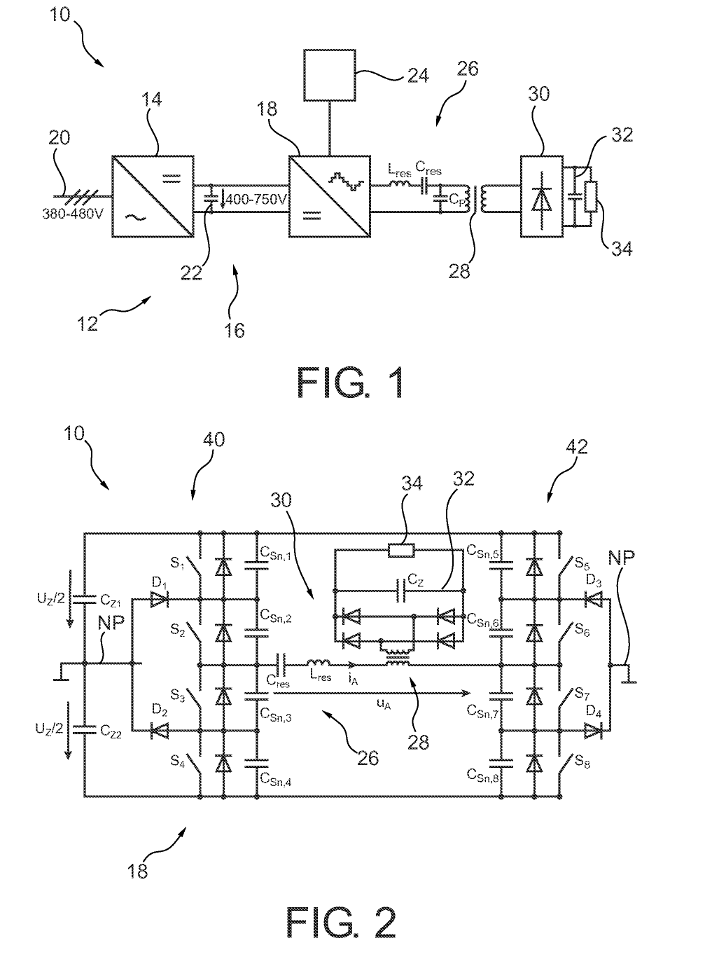

FIG. 1 shows an X-ray device 10 with an electrical energy supply system 12 comprising an input rectifier 14, a DC-link 16 and a 5-level inverter 18.

The rectifier 14 may be a (passive) B6 rectifier with three half-bridges and may be connected to a power grid 20, for example with three phases. The power grid may have a voltage between 360 V to 480 V depending on the general grid voltage of specific countries. The rectifier 14 rectifies the AC voltage from the power grid 20 and supplies the generated DC voltage into the DC-link 16.

The DC-link 16 interconnects the rectifier 14 and the inverter 18 and has a capacitor 22 for storing electrical energy.

The inverter 18 is an active element and is controlled by the controller 24. In particular, the inverter 18 has active power semiconductor switches that are switched on and off by the controller 24 in such a way that a 5-level AC output voltage from the DC voltage is generated. The 5-level AC output voltage is supplied to a resonant circuit 26. With respect to a (conventional) energy supply system that has a DC-DC converter and an H-bridge inverter, the combination of the DC-DC converter and the H-bridge inverter is substituted by the 5-level inverter 18. The 5-level-inverter 18 may generate the same output power in the same frequency range within an uncontrolled DC-link voltage range of 400 V to 750 V. For reducing the switching power losses, the controller 24 may be adapted to operate the inverter in a Zero-Voltage-Switching mode as will be explained in detail with respect to the following figures.

According to an embodiment of the invention, the electrical energy supply system 12 comprises an input rectifier 14 for rectifying an input voltage into a DC voltage, an inverter 18 with semiconductor switches for generating an AC output voltage from the DC voltage, a controller 24 for switching the switches of the inverter 18.

According to an embodiment of the invention, the inverter 18 is adapted for generating a 5-level AC output voltage.

According to an embodiment of the invention, the inverter 18 is directly connected to the input rectifier 14.

The X-ray device 10 further comprises, the resonant circuit 26 or resonant tank 26, a transformer 28, an output rectifier 30 and a load 34 connected in parallel to a capacitor 32 at the output of the output rectifier 30.

In general, the element 30 may be or may comprise a combination of a rectifier and a high voltage cascade, for example various voltage doublers.

The resonant circuit 26 comprises an inductor Lᵣₑₛ and a capacitor Cᵣₑₛ connected in series with the transformer 28 and in particular with the inner parasitic capacitance C_{P} of the transformer 28 and may be seen as an LCC resonant tank 26 energy conversion. The resonant circuit 26 may be adapted for filtering out higher harmonics of the AC output voltage of the inverter 18 and thus may smooth the AC output voltage of the inverter 28. Furthermore, the resonant tank circuit 26 may be designed for the lowest value of the uncontrolled DC-link voltage and 600 V semiconductors may be used.

The transformer 28 may be a step-up transformer for transforming the AC output voltage (smoothed by the resonant circuit 26) from the inverter 18 into a higher AC voltage that may be rectified by the rectifier 30 and supplied to the load 34.

According to an embodiment of the invention, the electrical energy supply system 12 comprises a step-up transformer 28 for transforming the AC output voltage.

According to an embodiment of the invention, the electrical energy supply system 12 comprises a resonant circuit 26 between the inverter 18 and the transformer 28 for filtering the AC output voltage into a sinusoidal AC output voltage.

The rectifier 30 may be a (passive) B2 rectifier with two half bridges.

According to an embodiment of the invention, the electrical energy supply system 12 comprises an output rectifier 30 for rectifying the AC output voltage to a DC output voltage to be supplied to the load 34.

The load 34 may be an X-ray tube.

According to an embodiment of the invention, the electrical energy supply system 12 is adapted for supplying an X-ray tube 34 with electrical energy.

FIG. 2 shows a circuit diagram for parts of the device 10, in particular the 5-level inverter 18 combined with the resonant circuit 26, the transformer 28, rectifier 30, capacitor 32 and load 34.

The inverter 18 is connected to two DC-link capacitors C_{Z1} and C_{Z2} each of which provide half of the voltage U_{Z}/2 of the DC-link 16. Both capacitors are connected to the neutral point NP.

The inverter 18 comprises two half-bridges 40, 42 each of which is adapted to generate three voltage levels (−U_{Z}/2, 0+U_{Z}/2). The half-bridges are connected in parallel to the two DC-link capacitors C_{Z1}, C_{Z2}. Together, the two half bridges 40, 42, and therefore the inverter 18 are adapted to generate five voltage levels (−U_{Z}, −U_{Z}/2, 0+U_{Z}/2, +U_{Z}).

The half bridge 40 comprises the semiconductor switches S₁ to S₄ connected in series and the two clamping diodes D₁, D₂. The half bridge 42 comprises the semiconductor switches S₅ to S₈ connected in series and the two clamping diodes D₃, D₄. A freewheeling diode is connected in parallel to each semiconductor switch. The half bridges 40, 42 and therefore the inverter 18 are neutral point clamped through the diodes D₁, D₂ and D₃, D₄, respectively.

According to an embodiment of the invention, the inverter 18 comprises two half bridges 40, 42.

According to an embodiment of the invention, each half bridge 40, 42 comprises four semiconductor switches S₁ to S₈.

According to an embodiment of the invention, each half bridge 40, 42 is neutral point clamped.

The 5-level inverter 18 is adapted to operate with a DC-link voltage range of 400-800V. However, 600V semiconductors may be used for the switches, diodes and capacitors of the inverter, since only half of the DC-link voltage is applied to the switches, diodes and capacitors.

Each half-bridge 40, 42 is based on a neutral point clamped three-level inverter developed by Nabae et al. (A. Nabae, I. Takahasi, and H. Akagi. “A new neutral-point-clamped PWM inverter”, IEEE Transactions on Industry Applications, Vol. 1A-17, No. 5, September/October 1981).

The 5-level inverter 18 comprises eight active switches S₁ to S₈ combined with 4 clamping-diodes D₁ to D₄. In a standard H-bridge inverter only four active switches are necessary. Compared with the above mentioned power supply with a combination of DC-to-DC converter and H-bridge inverter, the semiconductors and passive components (e.g. capacitors and inductors) of the DC-DC converter providing the regulated DC link voltage have to be taken into account. Thus, the kVA-rating of the semiconductors of the present system may be nearly the same, but the material costs for the passive components may be lower.

A snubber capacitor C_{Sn} is connected in parallel to each semiconductor switch. The snubber capacitors C_{Sn, 1} to C_{Sn, 8} may be used for the Zero-Voltage-Switching mode resulting in a high switching frequency combined with very low switching power losses. When a snubber capacitor is connected in parallel to a semiconductor switch, the voltage across the semiconductor during turn-off will rise slower, which may support the Zero-Voltage-Switching of the semiconductor.

According to an embodiment of the invention, a snubber capacitor C_{Sn, 1} to C_{Sn, 8} is connected in parallel to each semiconductor switch S₁ to S₈.

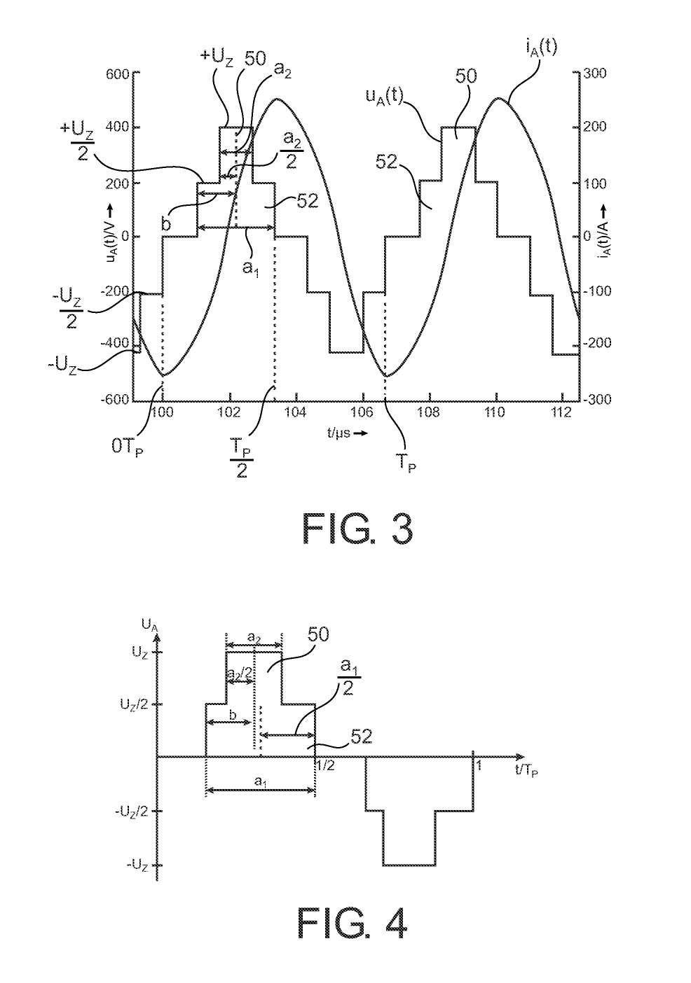

FIG. 3 shows a diagram with the output voltage u_{A}(t) of the inverter 18 in a first switching mode. The inverter can generate five different output-voltage levels +U_{Z}, +U_{Z}/2, 0, −U_{Z}/2, −U_{Z}. The output voltage has a completely cycle with a time period T_{P}.

In FIG. 3 the output current i_{A}(t) of the inverter 18 through the transformer 28 is depicted. As shown in FIG. 3, the first two switching steps (from zero voltage level to +U_{Z}/2 and from +U_{Z}/2 to +U_{Z}) of the first half cycle of the output voltage u_{A}(t) between 0T_{P} and T_{P}/2 are performed, when the current i_{A}(t) is still negative. This may result in a Zero-Voltage-Switching mode for specific switches of the inverter. Without loss of generality assume the following scenario: Initially, the output voltage u_{A}(t) of the inverter 18 is zero while the active switches S₃ and S₆ are closed. Switch S₆ is now opened by the controller 24. The snubber capacitor C_{Sn, 6} causes a slow voltage increase across S₆ from 0 to U_{Z}/2. This switching action is termed Zero-Voltage-Switching during turn-off. Since the current i_{A}(t) is smaller than 0 during the switching, the current subsequently flows through snubber capacitors C_{Sn, 7} to C_{Sn, 8} and the freewheeling diodes in parallel to the switches S₇ and S₈. The switches S₇ and S₈ may be closed now by the controller 24 establishing the voltage level U_{Z}/2. Because the freewheeling diodes in parallel to S₇ and S₈ have nearly no resistance and therefore nearly no voltage drop across them the switches S₇ and S₈ may be switched under (nearly) zero voltage. This switching action is referred to as Zero-Voltage-Switching during turn-on. The output voltage u_{A}(t) of the inverter 18 is now equal to U_{Z}/2 and switches S₃, S₇ and S₈ are conducting.

The controller 24 may now open the active switch S3. The snubber capacitor C_{Sn, 3} causes a slow voltage increase across S₃ from 0 to U_{Z}/2. This switching action is again termed Zero-Voltage-Switching during turn-off. Since the current i_{A}(t) is still negative (see FIG. 3) during the switching, the current subsequently flows through snubber capacitors C_{Sn, 1} to C_{Sn, 2} and the freewheeling diodes in parallel to the switches S₁ and S₂. The switches S₁ and S₂ may be closed now by the controller 24 establishing the voltage level U_{Z}. The low voltage drop across the freewheeling diodes in parallel to S₁ and S₂ allow for the turn-on of S₁ and S₂ under almost zero-voltage condition. This switching action is again referred to as Zero-Voltage-Switching during turn-on.

For generating the desired switching pattern of the inverter 18, the controller 24 uses the duty-cycle parameters a₁, a₂ and the parameter b, which may be stored in the controller 24. The duty-cycle parameter a₁ controls the time period of the +U_{Z}/2 voltage level (and the −U_{Z}/2 voltage level respectively) which depends on the period time T_{P}. The length of the U_{Z}-level is set by the duty-cycle parameter a₂.

The following time periods are normalized with respect to T_{P}. At the beginning of a half cycle (i.e. at the time-point 0), the output voltage u_{A}(t) is zero see FIG. 4. The controller 24 waits for a duration equal to ½−a₁ with a₁ being smaller than ½ and commands a switching pattern so that the inverter may generate the voltage level U_{Z}/2. Then, the controller 24 waits for b−a₂/2 and switches the inverter 18 to generate the voltage level U_{Z}. Then, the controller 24 waits for a₂ and switches to inverter 18 to generate U_{Z}/2. In the end, the controller 24 waits for T_{P}/2 and switches the inverter 18 to generate 0 V. After that, a negative half cycle (between T_{P}/2 and T_{P}) is performed analogously (the positive voltages substituted by the corresponding negative voltages). This is repeated continuously.

The generated output voltage u_{A}(t) is a step function and has a U_{Z}-voltage block 50 or inner voltage block 50 (with the output voltage at U_{Z}) and an U_{Z}/2-voltage block 52 or outer voltage block 52 (with the output voltage at least U_{Z}/2).

FIG. 4 shows a diagram with a further output voltage u_{A}(t) that may be generated by the inverter 18. The parameter b may be used to shift the U_{Z}-voltage block 50 with respect to the U_{Z}/2-voltage block 52. Thus, the U_{Z}-voltage block 50 may be asymmetrically placed with respect to the U_{Z}/2-voltage block 52.

The parameter b may be smaller than a₁/2 and the center of the inner voltage block 50 may be left of the center of the outer voltage block 52.

According to an embodiment of the invention, the controller 18 is adapted to switch the semiconductor switches S₁ to S₈ such that an asymmetric pulse shape 50, 52 is generated from the inverter 18 in a half cycle of the AC output voltage.

According to an embodiment of the invention, the asymmetric pulse shape 50, 52 comprises an outer voltage block 52 in which the AC output voltage differs from zero.

According to an embodiment of the invention, the asymmetric pulse shape 50, 52 comprise an inner voltage block 50 within the outer voltage block 52 in which the AC output voltage is equal to the DC voltage;

According to an embodiment of the invention, the center of the inner voltage block 50 is different from the center of the outer voltage block 52.

According to an embodiment of the invention, the pulse shape 50, 52 has four or less different blocks with constant voltage.

According to an embodiment of the invention, the length a₂ of the inner voltage block 50 is shorter than then length a₁ of the outer voltage block 52.

According to an embodiment of the invention, the pulse shape 50, 52 is staircase shaped and has only one maximum.

According to an embodiment of the invention, the center of the inner voltage block 50 is left of the center of the outer voltage block 52.

According to an embodiment of the invention, the length a₁ of the outer voltage block 52 is smaller than the length of the half cycle.

According to an embodiment of the invention, the controller 24 is adapted to generate equally shaped positive and negative half cycles periodically.

Normally, when the switches S₁ to S₈ are conventionally switched in such a way that at least of most of the switching occurs in the Zero-Voltage mode, the phase shift between the fundamental of the voltage u_{A}(t) and current i_{A}(t) is large, which may result in a bad power factor. Due to a shift of the U_{Z}-block 50, the Zero-Voltage mode may be maintained by enhancing the power factor.

In the controller 24 the parameters a₁, a₂ and b may be set such that the switching losses are minimized and/or such that the power factor is maximized.

By setting of the control parameters a₁, a₂ and b the inverter 18 generates a voltage-time-product which may be nearly independent of the uncontrolled DC-link voltage. Consequently, the AC output-voltage may be characterized by the same fundamental like by a conventional H-bridge inverter.

By shifting the parameter b, the power factor may be increased and thus the current stress of the utilized power semiconductors will be minimized. The setting of the parameter b influences the important root mean square values of the currents inside the 5-level inverter 18 by maintaining the Zero-Voltage-Switching conditions.

The controller 24 may be adapted to generate different pulse shapes 50,52 for example depending in the input voltage of the power grid 20. For example, in a first mode, the controller may control the inverter 18 to generate the pulse shape of FIG. 3 and in a second mode to generate the pulse shape of FIG. 4.

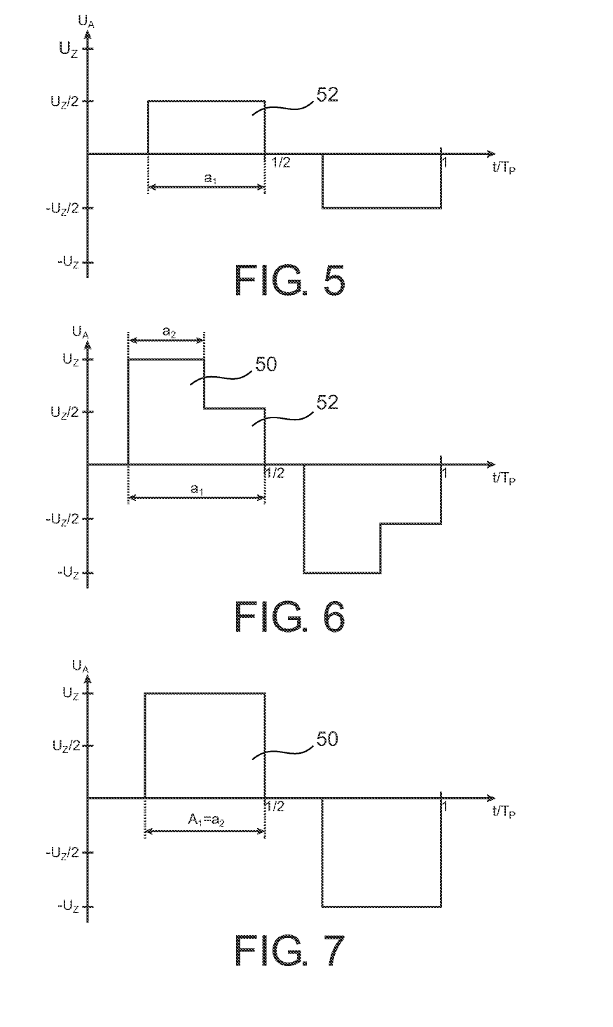

FIGS. 5 to 7 show diagrams with further output voltages that may be generated in further operation modes of the controller 24. The operation modes depend on the variation of the parameter a₁, a₂ and b.

In FIG. 5 the result for a₂=0 with a DC-link voltage of for example U_{Z}=800V is displayed. The inverter 18 generates a 3-level output-voltage with voltage levels ±400V and 0V. In other words, the pulse shape only has an U_{Z}/2-voltage block 52.

According to an embodiment of the invention, the controller 24, in an additional operation mode, is adapted for generating a rectangle pulse 52 with half of the DC voltage.

In FIG. 7, the same output-voltage levels are displayed as in FIG. 5, however with a DC-link voltage of 400V. For the pulse shape of FIG. 7, a₁=a₂ and b=0 has been set. In other words, the pulse shape only has an U_{Z}-voltage block 50.

According to an embodiment of the invention, the controller 24, in an additional operation mode, is adapted for generating a rectangle pulse 50 with the DC voltage.

FIG. 6 shows an example of the inverter output-voltage for the DC-link voltage range above 400V and below 800V. The duty-cycles parameters a₁ and a₂ are set to generate the constant voltage-time-product independent of the uncontrolled DC-link voltage. The parameter b is set to 0 in order to obtain the Zero-Voltage-Switching condition.

According to an embodiment of the invention, the inner voltage block 50 and the outer voltage block 52 start at the same time.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. An electrical energy supply system (12), comprising:
an input rectifier (14) for rectifying an input voltage into an DC voltage;
an inverter (18) with semiconductor switches (S₁ to S₈) for generating an AC output voltage from the DC voltage;
a controller (24) for switching the switches of the inverter (18);
wherein the inverter (18) is adapted for generating a 5-level AC output voltage;
wherein the controller (24) is adapted to switch the semiconductor switches (S₁ to S₈) such that an asymmetric pulse shape (50, 52) is generated from the inverter (18) in a half cycle of the AC output voltage;
wherein the asymmetric pulse shape (50, 52) comprises an outer voltage block (52) in which the AC output voltage differs from zero;
wherein the asymmetric pulse shape (50, 52) comprises an inner voltage block (50) within the outer voltage block (52) in which the AC output voltage is equal to the DC voltage;
wherein the center of the inner voltage block (50) is different from the center of the outer voltage block (52

2. (canceled)

3. The electrical energy supply system (12) of claim 1,
wherein the center of the inner voltage block (50) is left of the center of the outer voltage block (52).

4. The electrical energy supply system (12) of claim 1,
wherein the inner voltage block (50) and the outer voltage block (52) start at the same time.

5. The electrical energy supply system (12) claim 1,
wherein the length of the outer voltage block (52) is smaller than the length of the half cycle.

6. The electrical energy supply system (12) of claim 1,
wherein the controller (24), in an additional operation mode, is adapted for generating a rectangle pulse (52) with half of the DC voltage; and/or
wherein the controller (24), in an additional operation mode, is adapted for generating a rectangle pulse (50) with the DC voltage.

7. The electrical energy supply system (12) of claim 1,
wherein the controller (24) is adapted to generate equally shaped positive and negative half cycles periodically.

8. The electrical energy supply system (12) of claim 1,
wherein the inverter (18) comprises two half bridges (40, 42),
wherein each half bridge (40, 42) comprises four semiconductor switches (S₁ to S₈);
wherein each half bridge (40, 42) is neutral point clamped.

9. The electrical energy supply system (12) of claim 1,
wherein a snubber capacitor (C_{Sn, 1} to C_{Sn, 8}) is connected in parallel to each semiconductor switch (S₁ to S₈).

10. The electrical energy supply system (12) of claim 1, further comprising:
a step-up transformer (30) for transforming the AC output voltage; and/or
a resonant circuit (26) between the inverter (18) and the transformer (30) for filtering the AC output voltage into a sinusoidal AC output voltage.

11. The electrical energy supply system (12) of claim 1, further comprising:
an output rectifier (30) for rectifying the AC output voltage to a DC output voltage to be supplied to a load (34).

12. The electrical energy supply system (12) of claim 1,
wherein the inverter (18) is directly connected to the input rectifier (14).

13. An X-ray device (10) with an electrical energy supply system of claim 1,
wherein the electrical energy supply system (12) is adapted for supplying an X-ray tube (34) with electrical energy.

14. A use of an electrical energy supply system (12) of claim 1 in an X-ray device (10) for supplying an X-ray tube (30) with electrical energy.

15. A method for supplying a load (34) with electrical energy, comprising the steps of:
rectifying an input voltage into an DC voltage;
generating a 5-level AC output voltage from the DC voltage with an inverter (18);
controlling the inverter (18) such that an asymmetric pulse shape in a half cycle of the AC output voltage is generated;
wherein the asymmetric pulse shape (50, 52) comprises an outer voltage block (52) in which the AC output voltage differs from zero;
wherein the asymmetric pulse shape (50, 52) comprises an inner voltage block (50) within the outer voltage block (52) in which the AC output voltage is equal to the DC voltage;
wherein the center of the inner voltage block (50) is different from the center of the outer voltage block (52).
